(19) United States
(12) Patent Application Publication
(10) Pub. No.: US 2026/0327407 A1
(43) Pub. Date: Oct. 22, 2026

(54) BORON/TUNGSTEN COMPOSITES FOR STRUCTURAL FUSION REACTOR SHIELDING

(71) Applicant: Global Materials, Inc. DBA Specialty Materials Inc., Lowell, MA (US)

(72) Inventors: Monica Rommel, Lowell, MA (US); Stephen Pilioglos, Lowell, MA (US)

(21) Appl. No.: 19/239,533

(22) Filed: Jun. 16, 2025

Related U.S. Application Data
(60) Provisional application No. 63/713,187, filed on Oct. 29, 2024.

(51) Int. Cl. C08K 7/06; G21B 3/00; G21F 1/08

(52) U.S. Cl. CPC C08K 7/06; G21F 1/085; C08K 2201/003; G21B 3/00

(57) ABSTRACT

A polymer-reinforced composite. The composite comprises: a radiation-resistant resin; and a fiber reinforcement. The fiber reinforcement includes: a plurality of boron fibers including a tungsten core; and a plurality of tungsten fibers.

### CROSS REFERENCE TO RELATED APPLICATIONS

This application claims the benefit of U.S. Provisional Application No. 63/713,187, filed on Oct. 29, 2024, and entitled “BORON/TUNGSTEN COMPOSITES FOR STRUCTURAL FUSION REACTOR SHIELDING,” the entirety of which is hereby incorporated by reference.

### BACKGROUND

### Description of the Related Art

Recently, clean energy and fusion power has been a topic of increased interest. Fusion power can be employed in terrestrial and space-based reactors and propulsion systems. Fusion reactors produce electrical power from energy released in a nuclear fusion reaction.

In fusion reactor systems, monolithic elemental materials are used for the fusion reactor's framework due to their structural properties. Separate shielding materials are used with the fusion reactors for effective radiation shielding. This results in relatively high costs and these structures/shielding combinations occupy substantial space. Typically, the shielding materials are not readily tunable for the radiation environments they encounter.

### SUMMARY

The present document concerns a polymer-reinforced composite, comprising: a radiation-resistant resin and a fiber reinforcement. The fiber reinforcement includes a plurality of boron fibers including a tungsten core and a plurality of tungsten fibers. A diameter of the plurality of boron fibers may be within the range between about 3 mils to about 10 mils. A diameter of the plurality of tungsten fibers may be within the range between about 9 microns to about 254 microns. A mass ratio of tungsten to boron may be within the range between about 0% to about 90%, where the mass of tungsten is the sum of the total mass of tungsten within the boron cores of the composite and the total mass of tungsten wires of the composite. The polymer-reinforced composite may have: a tensile strength within the range between about 70 ksi to about 500 ksi; and/or a radiation shielding parameter within the range between about 5 to about 500 million grays.

The fiber reinforcement may be uniaxial and can be oriented in any direction from 0 to 360 degrees with respect to a predetermined axial direction (e.g., a longitudinal axis of the composite). The radiation resistant resin may be selected from the group consisting of epoxies, cyanate esters, bismaleimide and polyimides. A purity of at least one of the tungsten cores within the plurality of boron fibers and the tungsten within the plurality of tungsten fibers may be greater than or equal to about 1 wire per inch and should not exceed 250 fibers per inch.

The present document also concerns a radiation shielding material formed from a plurality of layers of the polymer-reinforced composite described above and extending between a first surface and a second surface. The radiation shielding material may comprise: a first area formed from a first plurality of composite layers having a first mass ratio of boron to tungsten; and a second area having a second plurality of layers having a second mass ratio of boron to tungsten, different from the first mass ratio of boron to tungsten. A tensile strength of the first area may be greater than a tensile strength of the second area. A radiation shielding parameter of the first area may be greater than a radiation shielding parameter of the second area.

Additionally or alternatively, the first surface may be formed from the first plurality of composite layers. The second surface may be formed from the second plurality of composite layers. The first mass ratio of boron to tungsten is less than the second mass ratio of boron to tungsten.

The present document further concerns implementing systems and methods of fabricating a radiation shielding material. The methods comprise: providing a fiber reinforcement including (i) a plurality of boron fibers including a tungsten core and (ii) a plurality of tungsten fibers; forming a plurality of prepreg layers comprising the fiber reinforcement and a polymer matrix; and curing the plurality of prepreg layers to form the radiation shielding material extending between a first surface and a second surface.

A diameter of the plurality of boron fibers may be within the range between about 3 mils to about 10 mils. A diameter of the plurality of tungsten wires may be within the range between about 9 to about 254 microns. The fiber reinforcement may be uniaxial. The radiation resistant resin may be selected from the group consisting of epoxies, cyanate esters, bismaleimides or polyimides. A purity of at least one of the tungsten wires within the plurality of boron fibers and the tungsten within the plurality of tungsten fibers may be greater than or equal to about 1.

The plurality of prepreg layers may comprise: a first area formed from a first plurality of prepreg layers having a first mass ratio of boron to tungsten; and a second area formed from a second plurality of layers having a second mass ratio of boron to tungsten. The second mass ratio of boron to tungsten is different from the first mass ratio of boron to tungsten. The first surface may be formed from the first plurality prepreg layers. The second surface may be formed from the second plurality of prepreg layers. The first mass ratio of boron to tungsten may be less than the second mass ratio of boron to tungsten. A tensile strength of the first area may be greater than a tensile strength of the second area. A radiation shielding parameter of the first area may be greater than a radiation shielding parameter of the second area.

### BRIEF DESCRIPTION OF THE DRAWINGS

This disclosure is facilitated by reference to the following drawing figures, in which like numerals represent like items throughout the figures.

FIG. 1 provides an illustration of a boron fiber including a tungsten core.

FIG. 2A provides an illustration that is useful for understanding fabrication of a composite radiation shielding layer. The radiation shielding layer is formed from a polymer matrix and a fiber reinforcement including the boron fiber of FIG. 1 and tungsten wires.

FIG. 2B provides a schematic top-down cross-sectional illustration of the radiation shielding layer with the fiber reinforcement extending in a first direction.

FIG. 2C provides a schematic top-down cross-sectional illustration of the radiation shielding layer with the fiber reinforcement extending in a second direction.

FIG. 3A provides an illustration of a radiation shielding material formed from a plurality of radiation shielding layers.

FIG. 3B provides a low magnification micrograph illustrating a side cross-sectional view of the radiation shielding laminate.

FIG. 3C provides a higher magnification micrograph illustrating a side cross-sectional view of the radiation shielding laminate.

FIG. 4 provides an illustration of a radiation shielding material including first and second areas having a first boron-tungsten ratio.

FIG. 5 provides another illustration of a radiation shielding material including multiple areas having first or second boron-tungsten ratios.

FIG. 6 provides an illustration of a radiation shielding material layer including first and second areas having first and second boron-tungsten ratios, respectively, with the fiber orientation in a y-direction.

FIG. 7 provides an illustration of another radiation shielding material layer including first and second areas having first and second boron-tungsten ratios, respectively, with the fiber orientation in an x-direction.

FIG. 8 provides a plot of mass percentage of tungsten as a function of boron fiber diameter to determine tungsten fiber diameter that achieves a target boron-tungsten ratio within a unit cell of the radiation shielding laminate.

FIGS. 9-10 each provides an illustration of a fusion device including shielding material(s).

FIG. 11 provides an illustration of a neutron irradiation spectrum employed for neutron irradiation testing.

FIG. 12 provides a gamma spectrum for irradiation of test panel 1.

FIG. 13 provides a summary of tensile strength and elastic modulus measured for test panel 2 and a baseline composite material.

### DETAILED DESCRIPTION

It will be readily understood that the solution described herein and illustrated in the appended figures could involve a wide variety of different configurations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

Reference throughout this specification to features, advantages, or similar language does not imply that all of the features and advantages that may be realized should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

As noted above, fusion reactors produce electrical power from energy released in a nuclear fusion reaction. In fusion reactor systems, monolithic elemental materials are used for the fusion reactor's framework due to their structural properties. Separate shielding materials are used with the fusion reactors for sound radiation shielding. This results in relatively high cost and this configuration occupies significant volume. Thus, there is an interest in composite materials to serve both structural and shielding needs in fusion devices. However, the use of fiber reinforced polymer composites in shielding applications has been limited due to the radiation resistance of the polymer. The polymer used needs to maintain mechanical properties after irradiation to ensure that the composite maintains its structural integrity. The tungsten wire used in this application, as well as the borided tungsten core in the boron fiber, will provide some shielding to the polymer to ensure structural integrity.

The present solution addresses this issue and other issues by providing a boron/tungsten composite that is specifically designed to have a dual purpose of providing structural integrity to the fusion or fission device and providing radiation shielding for the fusion or fission device. The boron/tungsten composite experiences no or a minimal amount of damage when exposed to fast and thermal neutrons. This advantage of the present solution is at least partially a result from use of a radiation resistant resin that maintains its mechanical properties after irradiation. The particulars of the radiation resistant resin will become evident as the discussion progresses.

The present solution can be used for various applications. Such applications include, but are not limited to, reactor applications, propulsion system applications, terrestrial applications, space applications and/or clean energy applications.

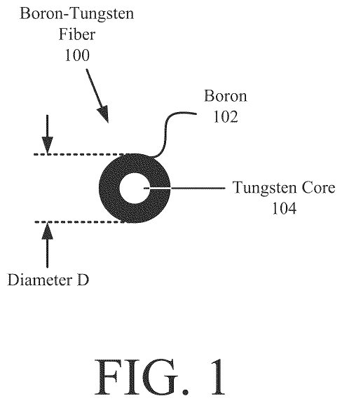

FIG. 1 provides an illustration showing a boron fiber 100 that is used to fabricate the present solution. The boron fiber 100 comprises boron 102 (e.g., amorphous boron) deposited upon a tungsten core 104. The deposition can be performed, for example, by cold walled chemical vapor deposition (CVD). The tungsten core 104 is resistively heated to a target temperature (e.g., about 1300° C.) in the presence of hydrogen gas (H₂) and boron trichloride gas BCl₃. This allows the reduction of the gaseous BCl₃, which deposits and infiltrates the tungsten core 104 and deposits elemental boron. In this manner, the tungsten core 104 is borided and contains δ-WB, W₂B₂, and WB₄ phases.

A diameter of the tungsten core 104 can be selected within the range from about 9 to about 12.7 microns. A thickness of the boron 102 can be selected within the range from about 67 microns to about 245 microns. A total diameter D of the boron fiber can be selected within the range from about 76 microns to about 254 microns (e.g., about 0.004 inches or 4 mils).

Boron naturally occurs mainly of the B10 and B11 isotopes at approximately 20% and 80%, respectively. B10 is a good neutron absorber and B11 acts as a neutron attenuator. This makes boron an attractive candidate for radiation shielding applications. Boron fiber-reinforced composites have higher compression properties than any other composite material, and can act as both a structural and a shielding component in environments where neutron shielding is desired (e.g., in fusion and fission reactors). Additionally, tungsten is a neutron reflector which slows down fast neutrons. Therefore, the present solution comprises a hybrid fiber-reinforced composite containing both the boron fiber and tungsten wire as a fiber reinforcement. The ratio of the boron to tungsten can be selectively modified to provide tailored strength and neutron control (e.g., neutron absorption and/or neutron reflection) as desired for any given application.

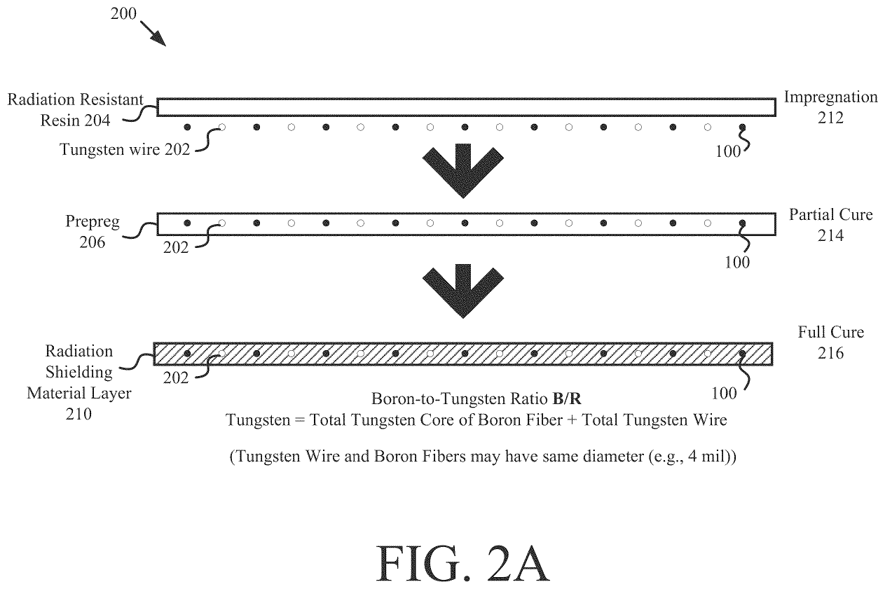

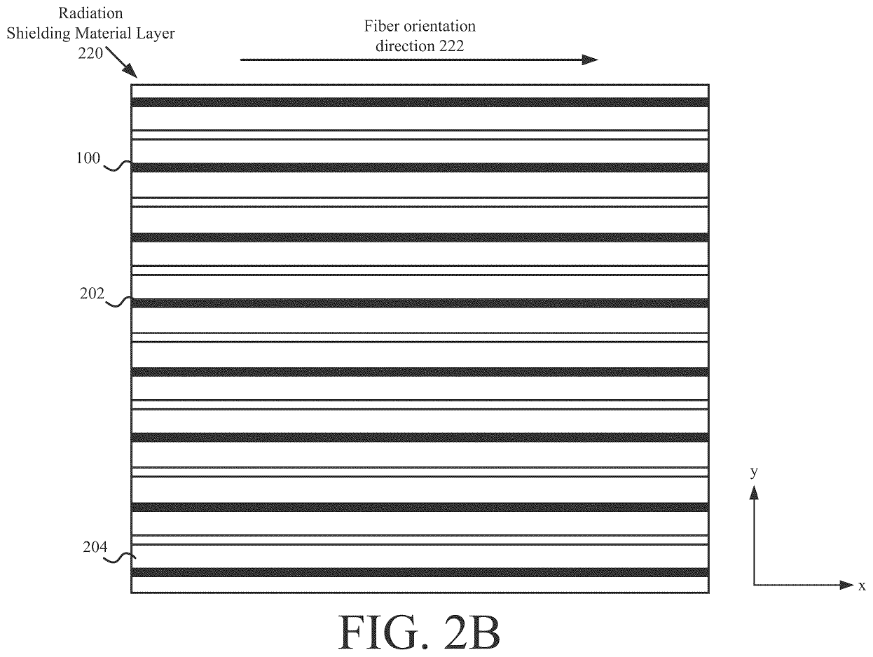

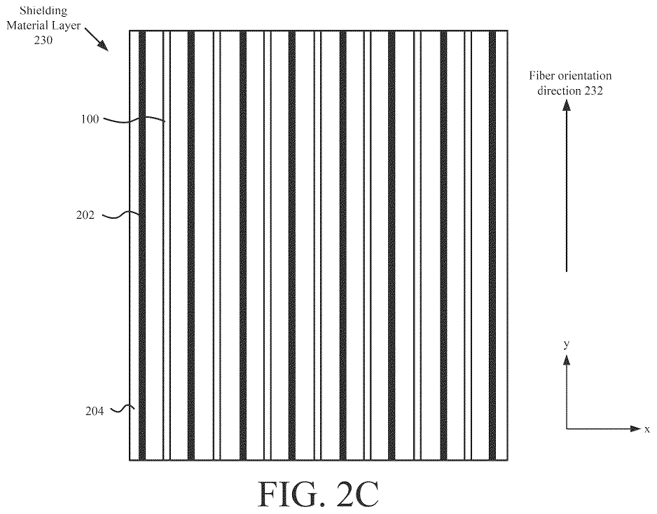

Referring now to FIG. 2A, there is provided an illustration of a manufacturing process 200 that is useful for understanding how a composite material of the present solution is manufactured. The manufacturing process 200 can include more or less steps than that shown in FIG. 2A. Also, the order of the steps can be different than that shown.

In an impregnation step 212, a fiber reinforcement comprising a plurality of boron fibers 100 and a plurality of tungsten wires 202 is provided. The fiber reinforcement can optionally additionally comprise carbon fibers. A diameter of the plurality of tungsten wires 202 can be selected within the range from about 76 to about 254 microns (e.g., about 0.003 to 0.010 inches). The diameter D of the plurality of boron fibers 100 and the diameter of the tungsten wires 202 can be selected to be about the same or different from one another.

The fiber reinforcement (the plurality of boron fibers 100 and the plurality of tungsten wires 202) is arranged in a predetermined orientation within a mold. The plurality of boron fibers 100 and the plurality of tungsten wires 202 can be arranged in a predetermined pattern with respect to one another. For example, a selected number of boron fibers 100 and a selected number of tungsten wires 202 can alternate row-by-row or in the same row. Other patterns of the plurality of boron fibers 100 and the plurality of tungsten wires 202 can be employed without limit. The lengths of boron fibers 100 and the tungsten wires 202 are nominally the same, within manufacturing tolerances. The tungsten wires 202 can have the same areal density or different areal densities in the fiber reinforcement.

Top views of shielding layers are provided in FIGS. 2B-2C. As shown, the fiber reinforcement is unidirectional (1D) within a given layer and oriented at a predetermined angle with respect to a predetermined axial direction (e.g., a longitudinal axis of the composite). For example, as shown in FIG. 2B, a fiber orientation direction 222 can be 0° with respect to a longitudinal axis of the composite (x-axis). In another example, shown in FIG. 2C, a fiber orientation direction 232 can be 90° with respect to the longitudinal axis (x-axis). That is, the fiber orientation direction 232 can be approximately orthogonal to the longitudinal axis (x-axis) and approximately parallel to an in-plane transverse axis (y-axis).

It can be appreciated that, in configurations of the composite employing multiple layers, the orientation of the fiber reinforcement within each layer can be independently selected without limit. For example, the orientation of the fiber reinforcement within a multi-layer composite can be bidirectional (2D; 0°/90°, ±θ) or three-dimensional (in 3 orthogonal directions).

In the impregnation step 212, a radiation resistant resin 204 is further impregnated into the fiber reinforcement. For example, the radiation resistant resin 204 can be a liquid that is poured over the fiber reinforcement. Pressure (e.g., positive pressure and/or negative pressure) and temperature can be further applied to the fiber reinforcement and the radiation resistant resin 204 to ensure flow of the radiation resistant resin 204 between the fiber reinforcement.

The radiation resistant resin 204 can be any polymer material having the following parameter(s): a radiation shielding parameter within the range from about 5 million Grays to 50 million Grays of Gamma Radiation with significant degradation. The radiation resistant resin 204 can be selected from the group consisting of esters, epoxies, and polyimide. For example, the radiation resistant resin 204 can be a cyanate ester. The resin shall yield final composite properties that achieve the following set of requirements:
Tensile Modulus: >30 Mpsi;
Tensile Strength>300 ksi;
Interlaminar Shear Strength>10 ksi;
Glass transition temperature, T_{g} (after post cure): >325° C.;
Max Use Temperature: 300° C.;
Minimum Use Temperature: 0° C.;
Thermal Cycles: 10,000 (0° C. to 300° C.);
Minimum pressure: 10-10 Torr;
Maximum pressure: 760 Torr;
Number vacuum cycles: 100;
Low Moisture Uptake: <0.3% by weight at 95% RH at saturation;
Resin minimum viscosity of <100,000 centipoise;
Maximum amount of Off-gassing: Less than 1% total mass loss (TML) and 0.1 collected volatile condensable material (CVCM) per ASTM E595;
Shelf Life: 5 years.
Out-time: 30 days at ambient temperature;
Highly Aromatic thermoset polymers; and
Optimized cure and post cure cycle.
   The maximum radiation stability and optimized cure and post cure cycle may be achieved by changing boron and tungsten masses to change radiation performance within certain bounds. For example, if there is any area that has a high fluence of slow neutron, then there would be a composite that is 95% boron and 5% tungsten versus something with fast neutrons where the material may have 75% boron and 25% tungsten so the tungsten slows down the neutrons so the boron can adsorb them.

In a partial curing step 214, a hybrid composite prepreg 206 can be formed. The fiber reinforcement impregnated with the radiation resistant resin 204 is heated to a first predetermined temperature (prepreg cure temperature) for a first predetermined time (prepreg cure time) to achieve a desired degree of partial cure. For example, the prepreg temperature can be selected from the range of about 20° C. to about 150° C. and the prepreg time can be selected from the range of about 0.5 ft/minute to about 30 ft/minute.

In a full cure step 216, fully cured radiation shielding material layer 210 can be formed. A single prepreg 206 or stack of prepregs 206 is heated to a second predetermined temperature (full cure temperature) and second predetermined time (full cure time) to achieve full cure. For example, the full cure temperature can be selected from the range of about 100° C. to about 380° C. and the full cure time can be selected from the range of about 60 min to about 360 min. Optionally, pressure can be applied during the full cure step 216.

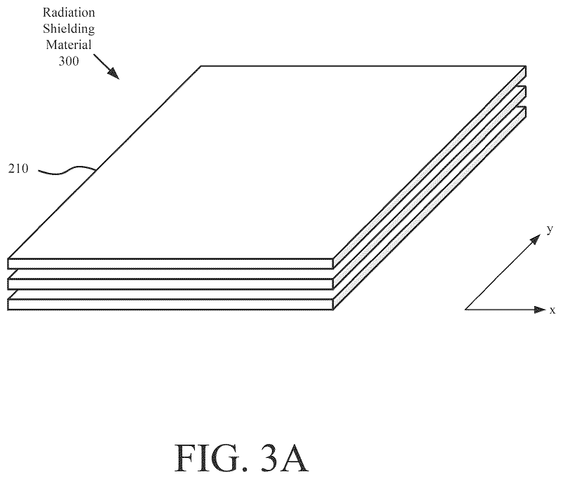

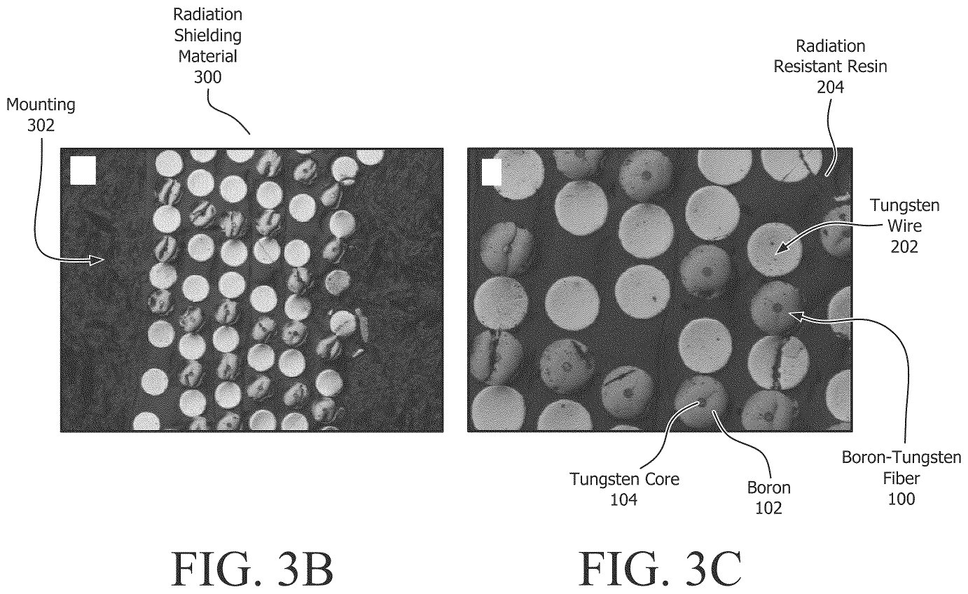

FIG. 3A provides an illustration of a multi-layer radiation shielding material 300 including a plurality of layers 210. Low and high-magnification micrographs of polished cross-sections of the multi-layer radiation shielding material 300 are further illustrated in FIGS. 3B-3C, respectively.

As noted above, a ratio of boron to tungsten (B/W) within respective radiation shielding material layers 210 can be selected. The amount of tungsten considered for the ratio includes (i) the total amount of tungsten forming the tungsten cores 104 of the boron fibers 100 and (ii) total amount of tungsten forming the tungsten wire 202.

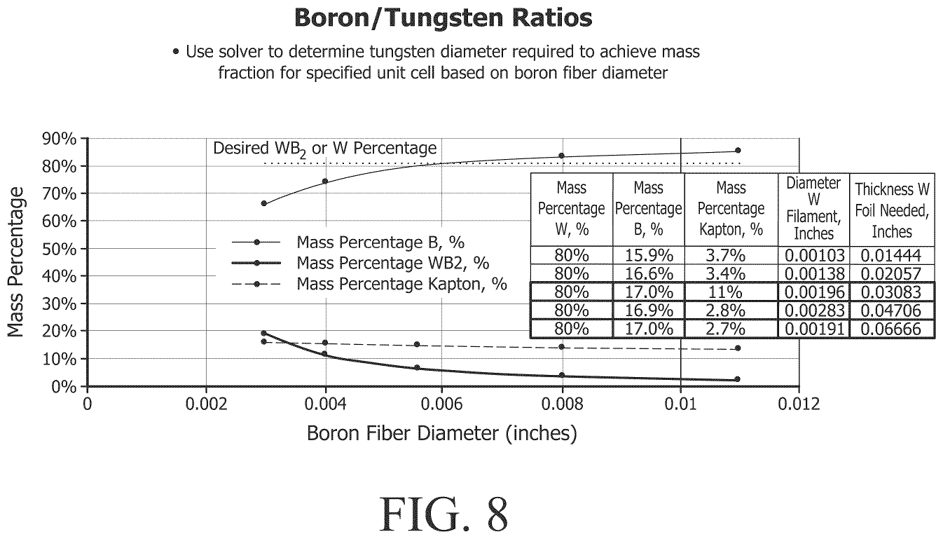

It should be noted that the boron adds structural stiffness to the radiation shielding material 300. The tungsten wire 202 provides minimal or no structural stiffness to the radiation shield material 312. However, the tungsten is able to slow the speed of neutrons. The boron is also able to absorb neutrons. Thus, the ratio B/W can be selected to optimize or otherwise improve the radiation shielding material 300 in terms of the tungsten's ability to slow down neutrons and the boron's ability to effectively absorb the slowed down neutrons. FIG. 8 provides a graph showing some illustrative ratios B/W. In some scenarios, the radiation shielding material includes ≥80% boron and ≤20% tungsten, or ≥90% boron and ≤10% tungsten. The present solution is not limited in this regard. Other percentages of boron and tungsten can be used.

In some scenarios, the boron fibers 100 have a predetermined density of fibers per inch. In general, as the number of boron fibers 100 increases within a radiation shielding material layer 210, the strength increases. Thus, the properties of the multi-layer radiation shielding material 300 can be varied by changing the ratio B/R on a per layer basis. In an example, the predetermined density of fibers can be greater than or equal to 208 fibers per inch of the composite. However, the predetermined density of fibers can also be lower than 208 fibers per inch, as necessary.

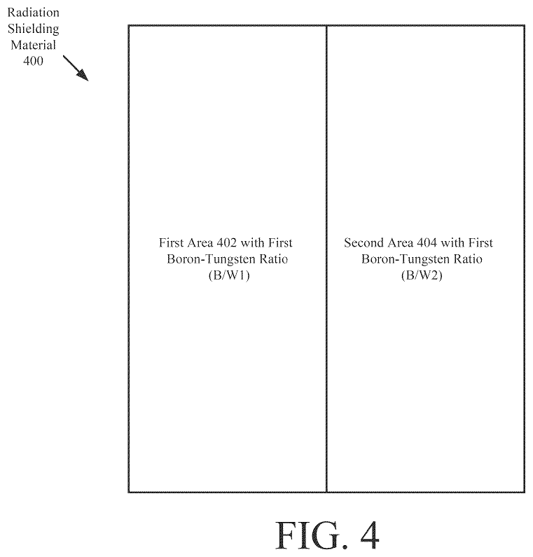

FIG. 4 provides an illustration of a multi-layer radiation shielding material 400 including a first area 402 that abuts a second area 404, where the first area 402 has a first ratio B/W1 and the second area 402 has a second ratio B/W2, different from B/W1. The first area 402 and the second area 404 can include one or more layers 210. The number of layers within each of the first area 402 and the second area 404 can be independently selected.

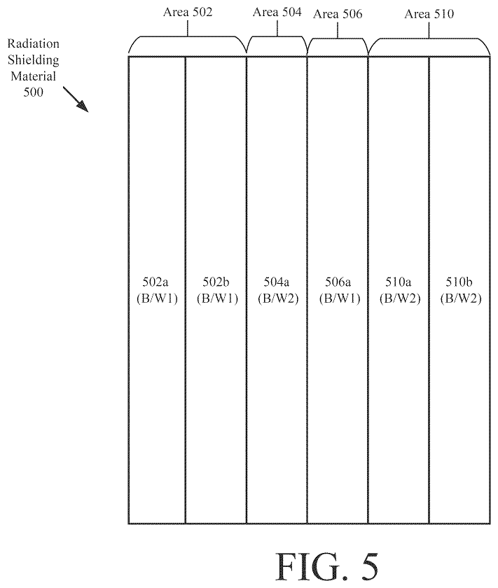

The number of areas including different ratios B/W can be varied and positioned with respect to one another as necessary for a given application. The number of layers within each area can be independently selected. FIG. 5 provides an illustration of a multi-layer radiation shielding material 500 including areas 502-510. Area 502 includes layers 502a, 502b having ratio B/W1, area 504 includes layer 504a having ratio B/W2, area 506 includes layer 506a having ratio B/W1, and area 510 includes layers 510a, 510b having ratio B/W2.

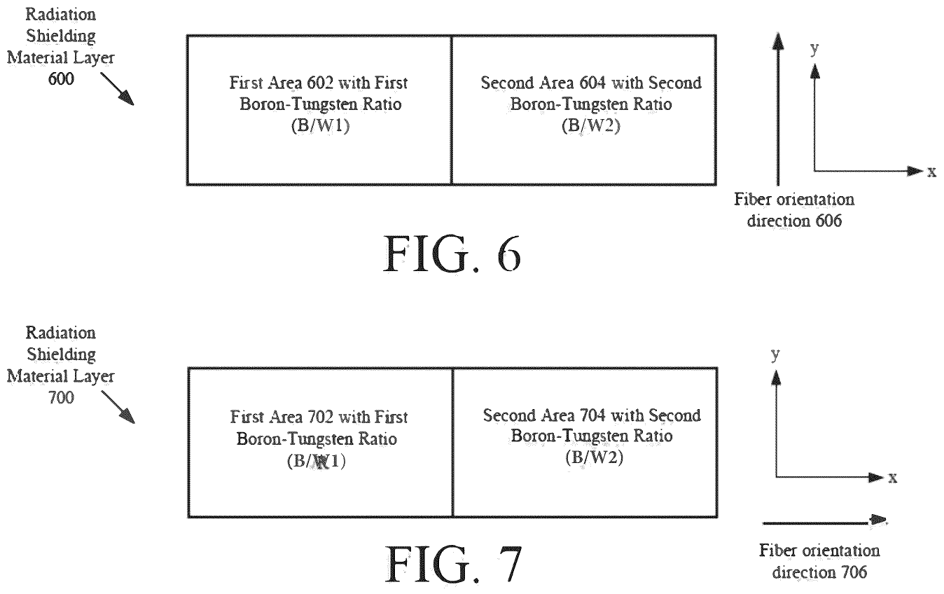

Alternatively, the ratio B/W may also vary within a single radiation shielding material layer 210 in accordance with a given application. FIG. 6 provides an illustration of a multi-layer radiation shielding material 600 including a first area 602 that abuts a second area 604, where the first area 602 has a first ratio B/W1 and the second area 402 has a second ratio B/W2, different from B/W1. The first and second ratios B/W1, B/W2 can be achieved by varying the relative density of boron fibers 100 and tungsten wire 204 within the first and second areas 602, 604

As further shown, a fiber orientation direction 606 extends in the y-direction and the first and second areas 602, 604 abut one another in the x-direction. Thus, the ratio B/W is constant in the fiber orientation direction 606 within a given one of the first and second areas 602, 604 but changes when moving in the orthogonal direction (x-direction) from the first area 602 to the second area 604.

FIG. 7 provides an illustration of a radiation shielding material layer 700 including a first area 702 that abuts a second area 704, where the first area 702 has a first ratio B/W1 and the second area 702 has a second ratio B/W2, different from B/W1. The first and second ratios B/W1, B/W2 can be achieved by varying the relative density of boron fibers 100 and tungsten wire 204 within the first and second areas 702,704.

As further shown, a fiber orientation direction 706 extends in the x-direction and the first and second areas 702, 704 abut one another in the x-direction. Thus, the ratio B/W changes in the fiber orientation direction 706 from B/W1 to B/W2 when moving in the fiber orientation direction 706 from the first and second areas 702, 704 and stays constant when moving in the orthogonal direction within a given one of the first and second areas 702, 704.

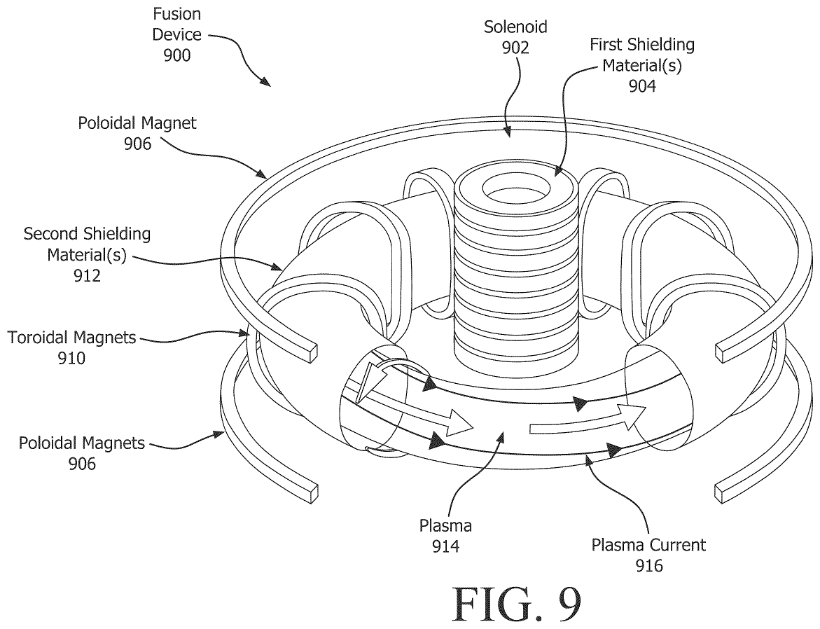

FIG. 9 provides an illustration of a magnetic confinement fusion device 900 suitable for use with the multi-layer radiation shielding material 300. While the illustrated fusion device 900 is a toroidal confinement device, it can be appreciated that the multi-layer radiation shielding material 300 can be employed with any other devices requiring neutron shielding without limit.

In fusion, light atomic nuclei are fused under pressure and heat to form heavier nuclei, releasing energy in the process. A plasma fuel is electromagnetically confined, and an electric current is introduced into the plasma, resulting in an increase in temperature. The plasma can also be heated by auxiliary systems (e.g., microwaves, radio waves, accelerated particles, etc.).

As shown, the device 900 comprises a solenoid 902, first shielding material(s) 904, a plurality of poloidal magnets 906, a plurality of toroidal magnets 910, and second shielding material(s) 912. The solenoid 902 induces the magnetic flux change to initiate a plasma 914, generate plasma current 916, and maintain the plasma current 916 during operation. The first shielding material(s) 904 provide structural reinforcement and shield the solenoid 902 from nuclear particles (e.g., neutrons). The plasma 914 is magnetically confined by a magnetic field having two components, a toroidal component generated by the plurality of toroidal magnets 910 and a poloidal component generated the plurality of poloidal magnets 906. The second shielding material(s) provide(s) structural reinforcement and shield(s) the toroidal magnets 910 and the poloidal magnets 906.

The multi-layer radiation shielding material 300 can be employed, alone or in combination with other materials or material systems for use as the first shielding material 904, the second shielding material 912, or both.

As discussed above, increasing boron content increases tension, compression, and shear strengths, which is beneficial for structural reinforcement. Increasing boron content further provides increased absorption of neutrons. Tungsten content does not significantly influence the strength of the radiation shielding material 300 but acts to slow down fast neutrons generated during fusion. This slowing of the neutrons is beneficial, as it increases the likelihood of absorption of the neutrons when entering boron. Thus, to optimize structural reinforcement and neutron shielding provided by the radiation shielding material 300, the radiation shielding material 300 can include a plurality of radiation shielding layers 210 having different boron to tungsten ratios B/W.

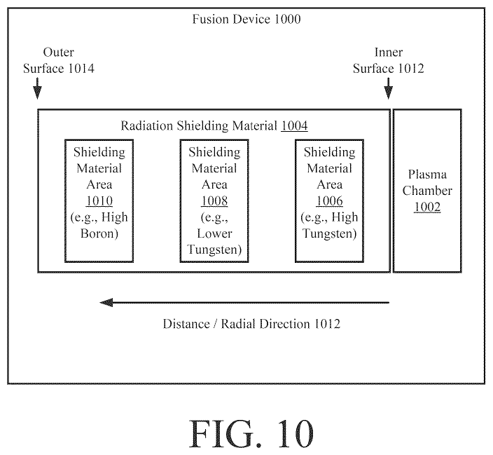

FIG. 10 provides an illustration of a fusion device 1000 including a plasma chamber 1002 containing a confined plasma and a radiation shielding material 1004 having a plurality of areas 1006, 1008, 1010. The plurality of area 1006, 1008, 1010 are respectively positioned in order of distance from the plasma chamber 1002. The area 1006 is closest to the plasma chamber 1002 and forms an inner surface 1012 of the radiation shielding material 1004. The area 1010 farthest from the plasma chamber 1002 forms an outer surface 1014 of the radiation shielding material 1004. The area 1008 is positioned between the layers 1006 and 1010.

The area 1006 is closest to the plasma chamber 1002 can be configured with a relatively high tungsten content relative to the areas 1008, 1010 (low B/W) to facilitate neutron slowing. The area 1010 farthest from the plasma chamber 1002 can be configured with a relatively high boron content relative to the areas 1006, 1008 (high B/W) to provide structural reinforcement and neutron absorption. The area 1008 between the areas 1006, 1010 can possess boron and tungsten content intermediate to that of areas 1006 and 1010 (intermediate B/W). It can be appreciated that the radiation shielding material can include greater or fewer areas as necessary for a given operating environment.

As discussed above, the areas 1006, 1008, 1010 can also include a plurality of layers 210. The layers can be stacked in the radial direction 1012 with respect to the plasma chamber 1002. Accordingly, the B/W ratio within a given area can also vary in the radial direction 1012.

### EXAMPLES

Mechanical testing and neutron irradiation testing were performed on two boron-reinforced composite panels.

### Materials

A first panel was fabricated from prepreg formed using only the boron fiber 100 as the fiber reinforcement and a cyanate ester as the resin (Toray® RS-3C; Toray Industries, Inc.).

Each prepreg included 208 boron fibers per inch (fpi). A prepreg tape was fabricated on a 1-step prepreg machine. Fifteen prepreg plies laid up and cured in an autoclave were employed to fabricate a fifteen-ply panel for mechanical property characterization.

A second panel was fabricated from prepreg formed using the boron fiber 100 and tungsten wire 204 (Nippon, see Table 1) as the fiber reinforcement and an epoxy as the resin (SMI 5505 epoxy resin; Specialty Materials, Inc.) on glass scrim. A prepreg was prepared having 40 vol. % boron fiber (4 mil diameter; 84 fpi) and 39.4 vol. % tungsten wire (4 mil diameter; 124 fpi). The total prepreg has 208 fpi (84+124). This was laid up as a unidirectional panel for mechanical characterization.

TABLE 1
Tungsten Wire Characterization Of Panel 2

| | Average | Chemical Composition | | | | | | | |
|---|---|---|---|---|---|---|---|---|---|
| | Particle | W | Fe | Mo | Ca | Si | Al | Mg | O |
| Type | size(μm) | (wt %) | (ppm) | (ppm) | (ppm) | (ppm) | (ppm) | (ppm) | (wt %) |
| WB1-10 | 1.0-1.2 | ≥99.9 | ≤100 | ≤150 | ≤30 | ≤30 | ≤20 | ≤10 | ≤0.4 |
| WB1-15 | 1.3-1.7 | ≥99.9 | ≤100 | ≤150 | ≤30 | ≤30 | ≤20 | ≤11 | ≤0.2 |
| WC1-20 | 1.8-2.4 | ≥99.9 | ≤100 | ≤150 | ≤30 | ≤30 | ≤20 | ≤12 | ≤0.1 |
| WC1-30 | 2.5-3.4 | ≥99.9 | ≤100 | ≤150 | ≤30 | ≤30 | ≤20 | ≤13 | ≤0.1 |
| WD1-45 | 3.5-5.4 | ≥99.9 | ≤100 | ≤150 | ≤30 | ≤30 | ≤20 | ≤14 | ≤0.1 |
| WD1-60 | 5.1-6.3 | ≥99.9 | ≤100 | ≤150 | ≤30 | ≤30 | ≤20 | ≤15 | ≤0.1 |

Other possible contaminants: Tin (Sn), Nickel (Ni), Carbon (C)

### Neutron Irradiation

### Panel 1

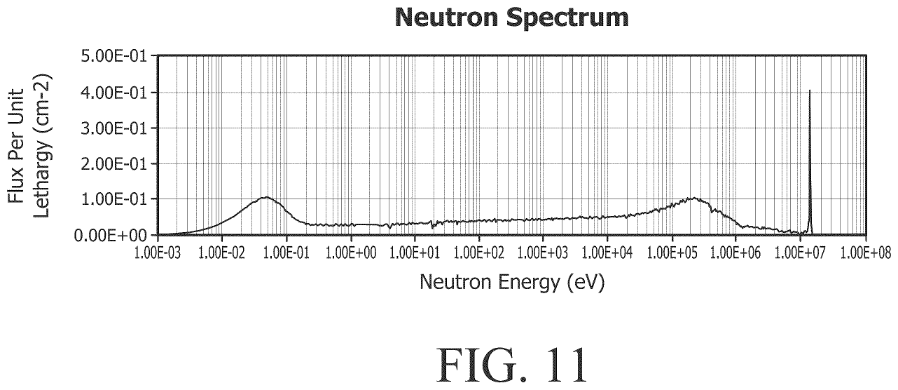

A sample of panel 1 having an area of 0.5 in ×1 in was subjected to neutron irradiation to determine if there are contaminants that activate upon irradiation using the neutron spectrum of FIG. 11. The test sample was run for 10 minutes at a reactor power of 5.7 MW. At this power, the thermal neutron flux is 7.3×10¹² neutrons/cm²-s and the fast (E>1 MeV) neutron flux is 9.5×10⁹ neutrons/cm²-s. This gives a fluence of 4.4×10¹⁵ neutrons/cm²-s thermal neutrons and 5.7×10¹² neutrons/cm²-s fast neutrons. The irradiation also included two NIST Standard Reference Materials: Coal Fly Ash (SRM 1633b) and Montana Soil (SRM 2710) to determine the trace element composition of the sample.

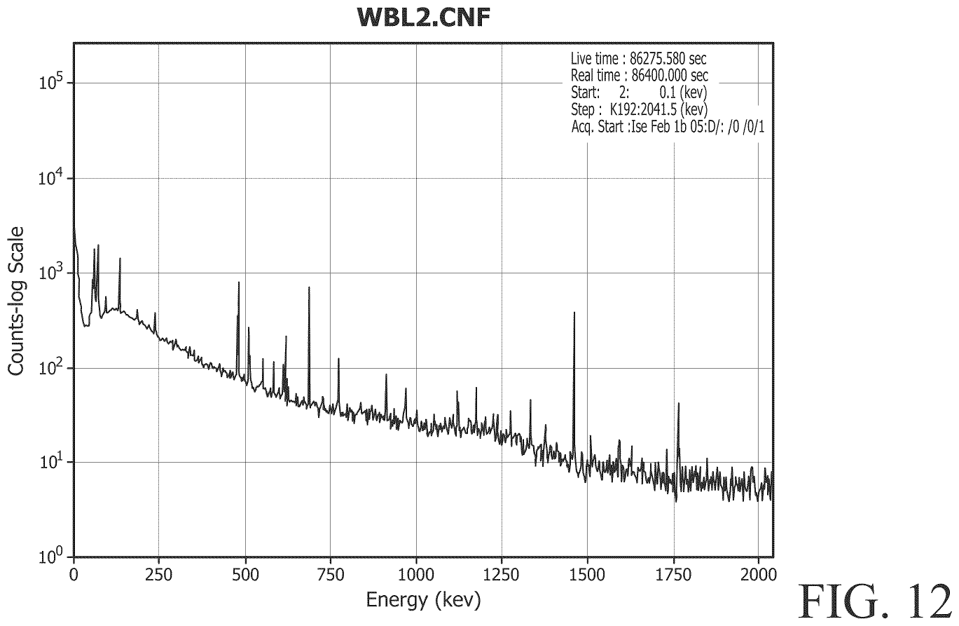

After analysis, the only element found in panel 1 that was not in the tungsten specification was a very small amount (6.8 ppm) of cobalt in the composite sample. Cobalt is the catalyst of the RS-3C resin. Adding this to the previous activation calculation for a 53.8-gram sample in the neutron beam for 6-hours does not significantly change the results. After 60-days decay, there is expected to be 788-microcuries of W-185, 54-nanocuries of W-181, and only 0.6-nanocuries of Co-60. The sample did not change in appearance after irradiation. The generated heat was calculated to be 1.2-watts. The gamma spectrum for the irradiated composite is illustrated in FIG. 12 and was analyzed the spectrum using Canberra Genie 2000 software. This initial exposure was used for screening to see if reaction of the neutrons with the boron fiber created helium gas would cause delamination of the composite. The neutron exposure conditions were designed to reflect the environment of a fusion reactor.

### Neutron Irradiation

### Panel 2

### Mechanical Properties

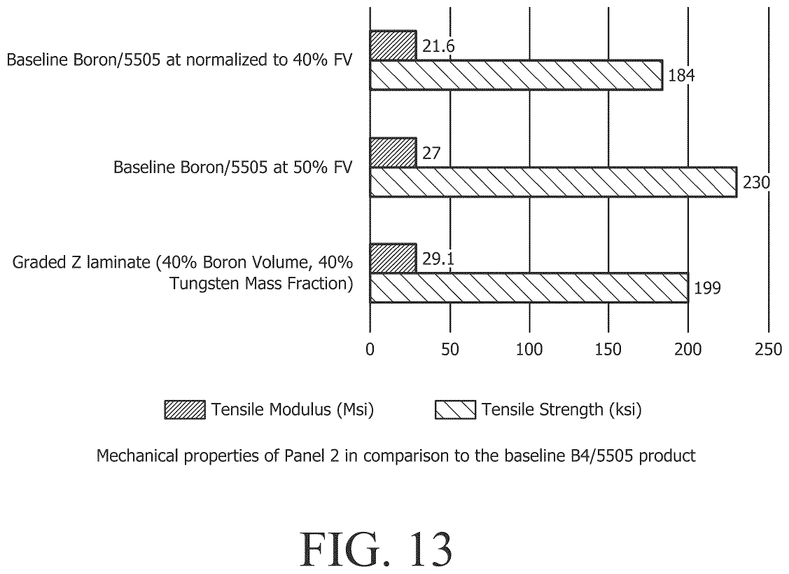

Panel 2 was subjected to tensile testing to evaluate tensile strength and tensile modulus. Similar testing was performed on a baseline boron-epoxy composite material, (SMI B4/5505; Specialty Materials, Inc.) was also performed for comparison. The B4/5505 uses 208 FPI of 102 micron Boron fiber in epoxy matrix. Testing results are illustrated in FIG. 13.

### CONCLUSION

From the neutron irradiation of Panel 1, the material is found to be very clean. The only additional element that was found was cobalt, which is the catalyst of the cyanate ester used in the composite panel.

From the mechanical testing of Panel 2, excellent translation of mechanical properties compared to the baseline was observed. The modulus of the tungsten is observed to have an influence on the composite modulus, as shown by the increase in modulus of panel 2 over the baseline.

In view of the foregoing, the present solution concerns a polymer-reinforced composite, comprising: a radiation-resistant resin; and a fiber reinforcement. The fiber reinforcement includes a plurality of boron fibers including a tungsten core and a plurality of tungsten fibers. A diameter of the plurality of boron fibers may be within the range between about 3 mils to about 10 mils. A diameter of the plurality of tungsten fibers may be within the range between about 9 microns to about 254 microns. A mass ratio of tungsten to boron may be within the range between about 0% to about 90%. The polymer-reinforced composite may have: a tensile strength within the range between about 70 ksi to about 500 ksi; and/or a radiation shielding parameter within the range between about 5 to about 500 million grays.

The fiber reinforcement may be uniaxial and can be oriented in any direction from 0 to 360 degrees. The radiation resistant resin may be selected from the group consisting of epoxies, cyanate esters, bismaleimide and polyimides. A purity of at least one of the tungsten wires within the plurality of boron fibers and the tungsten within the plurality of tungsten fibers may be greater than or equal to about 1 wire per inch and should not exceed 250 fibers per inch.

The present solution also concerns a radiation shielding material formed from a plurality of layers of the polymer-reinforced composite according to claim 1 and extending between a first surface and a second surface. The radiation shielding material may comprise: a first area formed from a first plurality of composite layers having a first mass ratio of boron to tungsten; and a second area having a second plurality of layers having a second mass ratio of boron to tungsten, different from the first mass ratio of boron to tungsten. A tensile strength of the first area may be greater than a tensile strength of the second area. A radiation shielding parameter of the first area may be greater than a radiation shielding parameter of the second area.

Additionally or alternatively, the first surface may be formed from the first plurality of composite layers. The second surface may be formed from the second plurality of composite layers. The first mass ratio of boron to tungsten is less than the second mass ratio of boron to tungsten.

The present solution further concerns implementing systems and methods of fabricating a radiation shielding material. The methods comprise: providing a fiber reinforcement including (i) a plurality of boron fibers including a tungsten core and (ii) a plurality of tungsten fibers; forming a plurality of prepreg layers comprising the fiber reinforcement and a polymer matrix; and curing the plurality of prepreg layers to form the radiation shielding material extending between a first surface and a second surface.

A diameter of the plurality of boron fibers may be within the range between about 3 mils to about 10 mils. A diameter of the plurality of tungsten wires may be within the range between about 9 to about 254 microns. The fiber reinforcement may be uniaxial. The radiation resistant resin may be selected from the group consisting of epoxies, cyanate esters, bismaleimides or polyimides. A purity of at least one of the tungsten wires within the plurality of boron fibers and the tungsten within the plurality of tungsten fibers may be greater than or equal to about 1.

The plurality of prepreg layers may comprise: a first area formed from a first plurality of prepreg layers having a first mass ratio of boron to tungsten; and a second area formed from a second plurality of layers having a second mass ratio of boron to tungsten. The second mass ratio of boron to tungsten is different from the first mass ratio of boron to tungsten. The first surface may be formed from the first plurality prepreg layers. The second surface may be formed from the second plurality of prepreg layers. The first mass ratio of boron to tungsten may be less than the second mass ratio of boron to tungsten. A tensile strength of the first area may be greater than a tensile strength of the second area. A radiation shielding parameter of the first area may be greater than a radiation shielding parameter of the second area.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

As used in this document, the terms “about”, “approximately”, and synonyms thereof modifying a stated numerical value include the stated numerical value and a predetermined range above and/or below the stated numerical value. The predetermined range can be less than or equal to any of 0.1%, 0.2%, 0.3%, 0.4%, 0.5%, 0.6%, 0.7%, 0.8%, 0.9%, 1%, 2%, 3,%, 4, %, 5%, 6%, 7%, 8%, 9%, or 10% of the stated numerical value.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A polymer-reinforced composite, comprising:
a radiation-resistant resin; and
a fiber reinforcement including:
a plurality of boron fibers including a tungsten core; and
a plurality of tungsten fibers.

2. The polymer-reinforced composite according to claim 1, wherein a diameter of the plurality of boron fibers is within the range between about 3 mils to about 10 mils.

3. The polymer-reinforced composite according to claim 1, wherein a diameter of the plurality of tungsten fibers is within the range between about 9 microns to about 254 microns.

4. The polymer-reinforced composite according to claim 1, wherein a mass ratio of tungsten to boron is within the range between about 0% to about 90%, and wherein the mass of tungsten is the sum of the total mass of tungsten within the boron cores of the composite and the total mass of tungsten wires of the composite.

5. The polymer-reinforced composite according to claim 1 having a tensile strength within the range between about 70 ksi to about 500 ksi.

6. The polymer-reinforced composite according to claim 1 having a radiation shielding parameter within the range between about 5 to about 500 million grays.

7. The polymer-reinforced composite according to claim 1, wherein the fiber reinforcement is uniaxial and can be oriented in any direction from 0 to 360 degrees.

8. The polymer-reinforced composite according to claim 1, wherein the radiation resistant resin is selected from the group consisting of epoxies, cyanate esters, bismaleimide and polyimides.

9. The polymer-reinforced composite according to claim 1, wherein a purity of at least one of the tungsten wires within the plurality of boron fibers and the tungsten within the plurality of tungsten fibers is greater than or equal to about 1 wire per inch and should not exceed 250 fibers per inch.

10. A radiation shielding material formed from a plurality of layers of the polymer-reinforced composite according to claim 1 and extending between a first surface and a second surface.

11. The radiation shielding material according to claim 10, comprising:
a first area formed from a first plurality of composite layers having a first mass ratio of boron to tungsten; and
a second area having a second plurality of layers having a second mass ratio of boron to tungsten, different from the first mass ratio of boron to tungsten.

12. The radiation shielding material according to claim 10,
wherein the first surface is formed from the first plurality of composite layers and the second surface is formed from the second plurality of composite layers; and
wherein the first mass ratio of boron to tungsten is less than the second mass ratio of boron to tungsten.

13. The radiation shielding material according to claim 10, wherein a tensile strength of the first area is greater than a tensile strength of the second area.

14. The radiation shielding material according to claim 10, wherein a radiation shielding parameter of the first area is greater than a radiation shielding parameter of the second area.

15. A method of fabricating a radiation shielding material, comprising:
providing a fiber reinforcement including:
a plurality of boron fibers including a tungsten core; and
a plurality of tungsten fibers;
forming a plurality of prepreg layers comprising the fiber reinforcement and a polymer matrix; and
curing the plurality of prepreg layers to form the radiation shielding material extending between a first surface and a second surface.

16. The method according to claim 15, wherein a diameter of the plurality of boron fibers is within the range between about 3 mils to about 10 mils.

17. The method according to claim 15, wherein a diameter of the plurality of tungsten wires is within the range between about 9 to about 254 microns.

18. The method according to claim 15, wherein the fiber reinforcement is uniaxial.

19. The method according to claim 15, wherein the radiation resistant resin is selected from the group consisting of epoxies, cyanate esters, bismaleimides or polyimides.

20. The method according to claim 15, wherein a purity of at least one of the tungsten wires within the plurality of boron fibers and the tungsten within the plurality of tungsten fibers is greater than or equal to about 1.

21. The method according to claim 15, wherein the plurality of prepreg layers comprises:
a first area formed from a first plurality of prepreg layers having a first mass ratio of boron to tungsten; and
a second area formed from a second plurality of layers having a second mass ratio of boron to tungsten;
wherein the second mass ratio of boron to tungsten is different from the first mass ratio of boron to tungsten.

22. The method according to claim 21,
wherein the first surface is formed from the first plurality prepreg layers and the second surface is formed from the second plurality of prepreg layers; and
wherein the first mass ratio of boron to tungsten is less than the second mass ratio of boron to tungsten.

23. The method according to claim 21, wherein a tensile strength of the first area is greater than a tensile strength of the second area.

24. The method according to claim 21, wherein a radiation shielding parameter of the first area is greater than a radiation shielding parameter of the second area.
